(19) United States
(12) Patent Application Publication
(10) Pub. No.: US 2015/0305959 A1
(43) Pub. Date: Oct. 29, 2015

(54) SEAT, BACK AND NECK SUPPORT CUSHION

(71) Applicant: RFS Innovation LLC, Brookville, IN (US)

(72) Inventors: Douglas E. Borgman, Brookville, IN (US); John D. Miller, Brookville, IN (US); Jeffrey L. Weisenbach, Batesville, IN (US); Kenneth L. Kramer, Greensburg, IN (US); Catherine Wagner, Osgood, IN (US); Michael B. Verkley, Cedar Grove, IN (US)

(73) Assignee: RFS INNOVATION LLC, Brookville, IN (US)

(21) Appl. No.: 14/673,492

(22) Filed: Mar. 30, 2015

Related U.S. Application Data
(60) Provisional application No. 61/972,021, filed on Mar. 28, 2014.

(51) Int. Cl. A61H 1/00; A47C 7/38; A47C 7/40; A47C 7/02; A47C 7/46

(52) U.S. Cl. CPC A61H 1/008; A47C 7/02; A47C 7/46; A47C 7/40; A47C 7/38

(57) ABSTRACT

A gel cushion seating, back, and neck surface is attached to or integrated with the seat and/or back sections of a chair. The gel cushion seating surface of the chair has a plurality of gel cushion cylinders arranged in an array to provide a rhythmically changing support area at multiple points on the occupant's back, neck, or buttocks and thighs. This provides a comforting massage, which reduces stress on the body associated with prolonged seating. The gel cushion back surface of the chair has a plurality of gel cushion cylinders arranged in a grid that provide a rhythmically changing support at multiple points on the occupant's lumbar and center back, also including the spine and neck. Various “cams” translate torque into the specified motion of gel cushion cylinders.

### REFERENCE TO RELATED APPLICATION

This application is a nonprovisional of and claims priority to U.S. Provisional Patent Application No. 61/972,021, titled “Lift Chair and Seat” and filed Mar. 28, 2014, which is hereby incorporated by reference in its entirety as if fully set forth.

### FIELD

The disclosed technology pertains to a mechanized seat, back and neck apparatus with a variable moving surface.

### BACKGROUND

Due to advanced age or certain medical conditions, some individuals find it difficult to sit for extended periods of time without discomfort. Home furniture, vehicle seating, medical facility seating, office furniture, and support surfaces are generally not designed for persons with reduced mobility and result in increased physical stress and strain from what is a common daily activity. Individuals suffering from reduced mobility also sometimes suffer from conditions that affect the circulatory and/or nervous systems, with the result that being seated for too long can cause health issues or discomfort.

Seating exists for reducing the strain of prolonged seating on the body, but are primarily passive systems such as specialized cushions or air mattresses, or active “massage” mechanisms that impose significant disturbance on the user.

What is needed, therefore, are improved seating support systems.

### SUMMARY

The technology disclosed herein can be used to build a supportive surface that can provide increased comfort and reduce stress on the body while seated or reclined. One exemplary embodiment of this technology is a seat with a gel-cushioned surface, portions of which can be automatically raised and lowered. A second exemplary embodiment of this technology is a lower- and center-back section with a gel-cushioned variable surface.

The seat has at least one seating surface under the buttocks and/or one surface supporting the back and/or one surface supporting the neck, each comprising a plurality of gel cushion cylinders arranged in a grid. Cams underneath the gel cushion cylinders are linked in two or more groups by two or more link bars underneath the grid. Each end of the two or more link bars terminates with a worm gear that engages a worm screw rotating drive. As the worm screw rotates, the cam attached to the link bar rotates between a high and a low position. When the cam is in a low position, a spring, pressure from the user's body and gravitational force, or other biasing means such as a mechanical linkage, will force the cylinder to the low position. As the link bar continues to rotate, the cam gradually rotates to drive the cylinder back to the high position. In this embodiment, each cam may be rotated in four 90-degree increments on the link bar, though other embodiments use more, fewer, or different increments. In one embodiment, three of the four positions are high, and one position is low. By arranging each cylinder cam in one of the four positions, a plethora of combinations are created. By turning the rods, the seating surface gradually changes the points on the user's body that are bearing more and less weight as the drive cylinders rotate to simulate the user moving about in the seat to find comfortable positions.

Similarly, other methods, machines, systems, and articles of manufacture could also be implemented based on this disclosure by those of ordinary skill in the art without undue experimentation, and so the preceding summary, as well as the descriptions and drawings set forth herein, should be understood as being illustrative only, and not limiting.

### BRIEF DESCRIPTION OF THE DRAWINGS

The drawings and detailed description that follow are intended to be merely illustrative and are not intended to limit the scope of the invention as contemplated by the inventors. The

[symbol]

FIG. 1 is an exploded view of an exemplary gel cushion cylinder.

FIG. 2 is a front, top perspective view of a plurality of exemplary gel cushion cylinders linked together by connecting rods.

FIG. 3 is a front, top perspective view of an exemplary grid of gel cushion cylinders with worm gear and worm screw.

FIG. 4 is a front elevation view of the array of gel cushion cylinders of FIG. 3, with different cylinders in different positions.

FIG. 5 is a front elevation view of an exemplary chair with a gel cushion cylinder seating and back surface.

FIG. 6 is a top plan view of the exemplary chair of FIG. 5.

FIG. 7 is a set of isometric and perspective views of a lumbar support cushion according to an alternative or additional embodiment.

FIG. 8 is a top plan view of an alternative array of gel cushion cylinders using a strap-grid-based means of supporting, raising, and lowering the cylinders.

FIG. 9 is a front side view of the alternative array of FIG. 8.

FIG. 10 is a top perspective view of the alternative array of FIG. 8.

FIG. 11 is a bottom perspective view of the alternative array of FIG. 8.

FIG. 12 is a side view of another alternative array using a disc cam technique for supporting, raising, and lowering the cylinders.

FIG. 13 is a bottom perspective view of still another alternative array using a straight cam technique for supporting, raising, and lowering the cylinders.

FIG. 14 is a bottom perspective view of yet another alternative array using a leaf spring technique for supporting, raising, and lowering the cylinders.

### DETAILED DESCRIPTION

The inventors have conceived of novel technology which, for the purpose of illustration, is disclosed herein as applied in the context of a seat with a gel cushion seating and back/neck supporting surface. While the disclosed applications of the inventors' technology satisfy a long-felt but unmet need in the art of seating and reclining for those with special health and wellness care needs, it should be understood that the inventors' technology is not limited to being implemented in the precise manners or applications set forth herein, but could be implemented in other manners and applications without undue experimentation by those of ordinary skill in the art in light of this disclosure. Accordingly, the examples set forth herein should be understood as being illustrative only, and should not be treated as limiting.

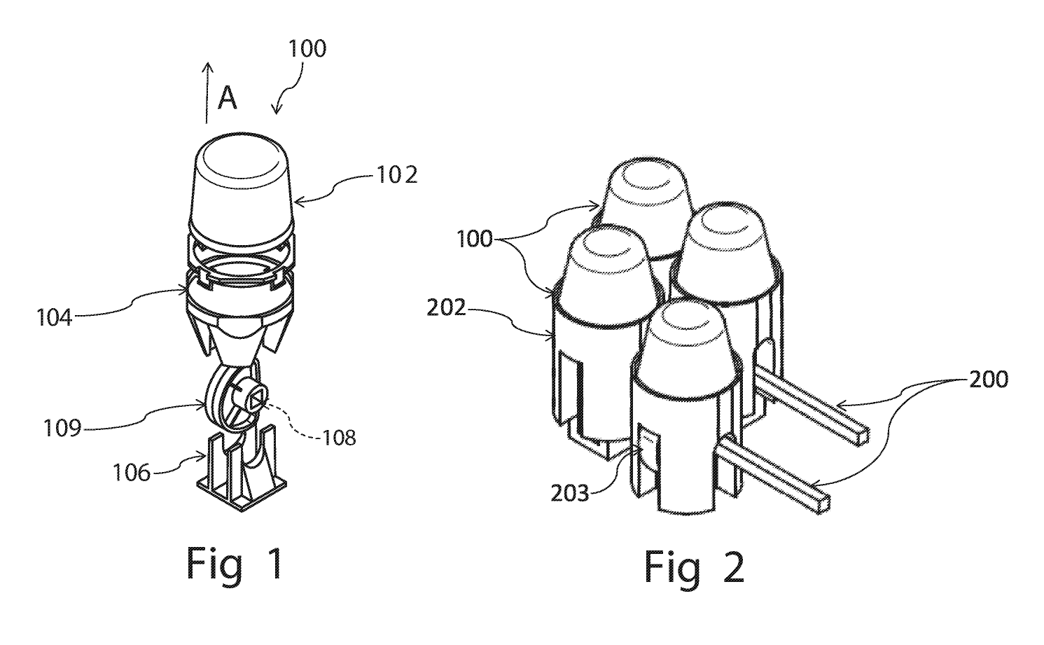

Turning now to FIG. 1, an exemplary gel cushion cylinder, or cell, (100) is illustrated. The gel cushion cylinder (100) as depicted has a conical head portion (102). In various embodiments, the conical portion (102) can be conical, cylindrical, hexagonal, or any other shape desired. The head portion (102) is attached to a base portion (104) and is pliable, or resiliently deformable, under pressure. The base portion (104) provides a rigid base to stabilize the pliable head portion (102) as it is displaced. Cam rod (108) (passing to or through gel cushion cylinder (100) along a line perpendicular to FIG. 1) is rotated, thereby delivering torque to cam (109). This rotation moves base portion (104) up and down in direction A (and the opposite direction) while stem (106) stabilizes gel cushion cylinder (100) and keeps it in a consistent alignment.

In some embodiments, base portion (104) is urged down (opposite direction A), at least during the portion of the rotation of cam rod (108) intended to move base portion (104) in that direction. For example, one or more springs might be attached at one end to the underside of base portion (104) and at the other to some portion of stem (106), biasing base portion (104) opposite to direction A. In other embodiments, the bottom of base portion (104) is connected with cam (109) or other structures so that base portion (104) is forced down when it is not being lifted by cam (109).

FIG. 2 shows four gel cushion cylinders (100) interconnected in an array. A cylinder housing (202) encases a gel cushion cylinder (100) and allows it to ascend and descend along a linear path. A link bar (200) passes through one or more gel cushion cylinders (100), linking them together into a group. Under each cylinder housing (202), the cam (203), which is rotated by the link bar (200), causes ascending and descending of the cylinder housing (202), causing the gel cushion cylinders (100) to ascend and descend.

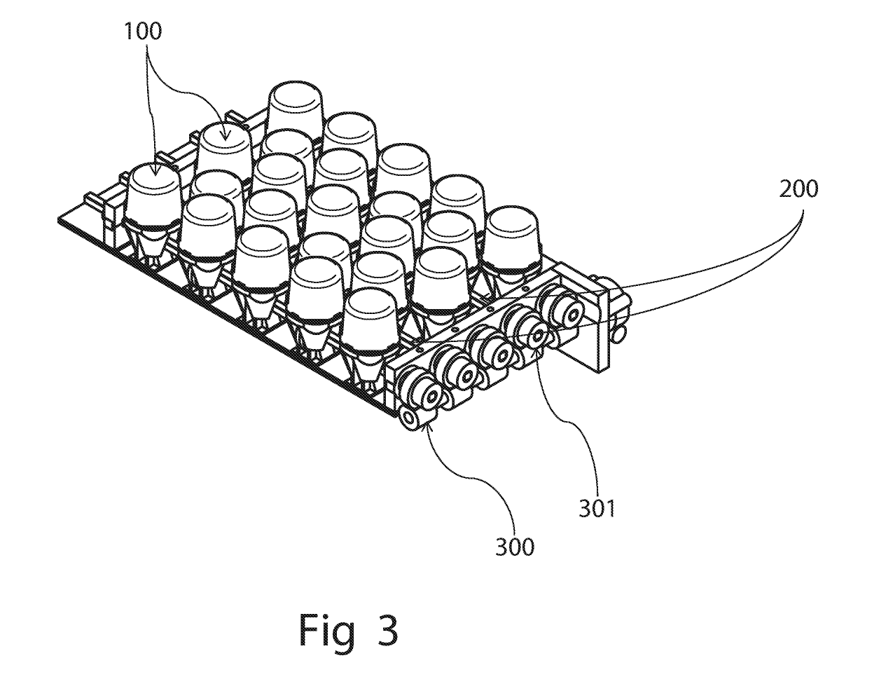

FIG. 3 shows a plurality of gel cushion cylinders (100) arranged into a seating surface-sized array with a mechanism operable to cause groups of the gel cushion cylinders to ascend and descend. A plurality of link bars (200) underlie the gel cushion cylinders (100), linking them together into groups. The link bars (200) terminate with a worm gear (301) that engages a worm screw (300) rotating drive. In this embodiment, the link bar periodically rotates each cam in 90-degree increments, thereby raising and lowering each gel cushion cylinder (100) through a sequence of four positions. In alternative embodiments, the sequence includes a different number of positions (corresponding to a different amount of rotation each time), and might include fixed or variable amounts of time between each partial rotation. For example, the system might pause ten seconds, thirty seconds, one minute, two minutes, five minutes, ten minutes, a half hour, or any other period of time between partial rotations as will occur to those skilled in the art.

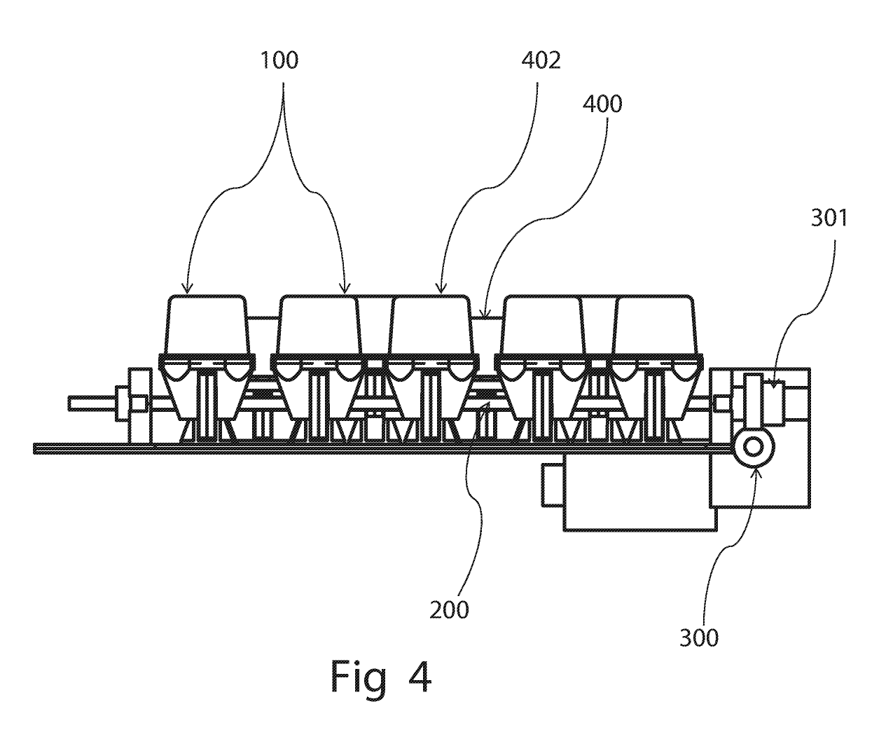

FIG. 4 shows a front elevation view of a plurality of gel cushion cylinders (100) linked into groups by a plurality of link bars (200), with each end terminating with a worm gear (301). Because of the differing shapes and/or orientations of the cams in each gel cushion cylinder (100) at any given point in time, the present embodiment has some gel cushion cylinders (100) in a lowered position (400), while others are in a raised position (402). (Other embodiments might or might not have this feature.) As worm gear (301) rotates, different gel cushion cylinders (100) proceed through a cycle of lowering and raising driven by their respective cams, thereby relieving pressure on the user of the seat at points corresponding to the gel cushion cylinders (100) in the lowered position (400).

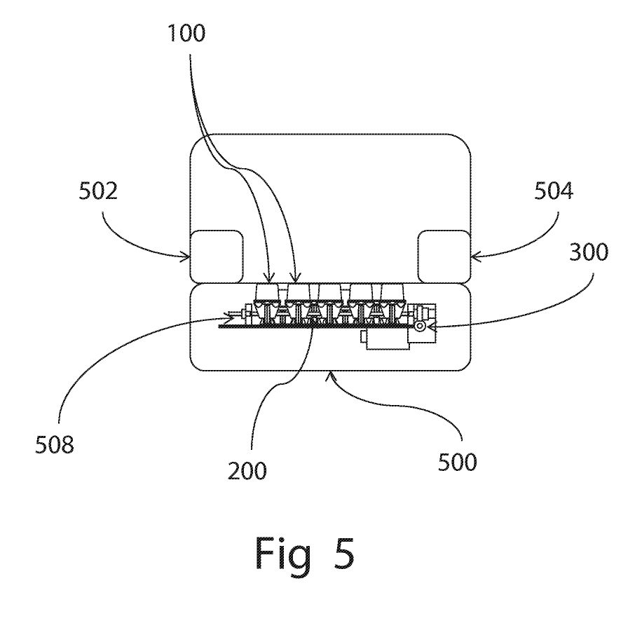

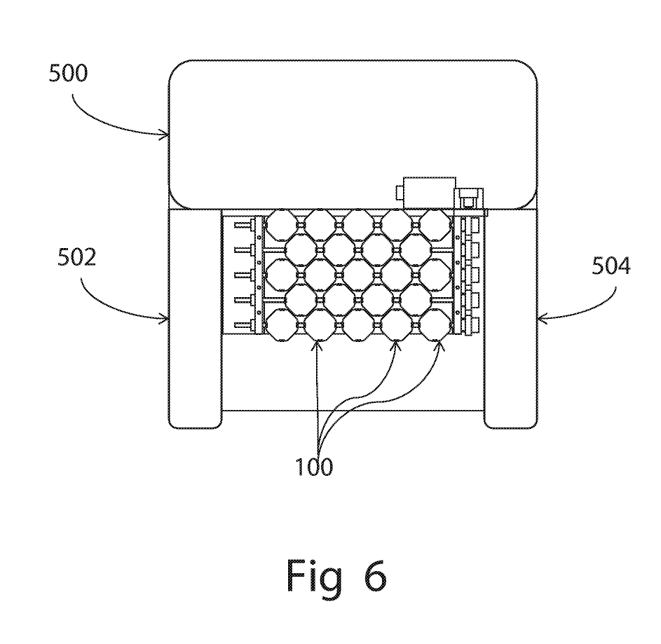

FIG. 5 shows a front elevation view of an exemplary chair (500) with an exemplary seating surface (508) installed between a first armrest (502) and a second armrest (504). Gel cushion cylinders (100) that are in a raised position are at a similar elevation level as the seating surface, while gel cushion cylinders (100) that are in a lowered position sit below the overall level of the seating surface. FIG. 6 shows a top plan view of the exemplary chair (500) with a plurality of gel cushion cylinders (100) arranged in an array to form a seating surface.

In one embodiment of the exemplary seating surface (508) of FIG. 5, a cover is installed over the gel cushion cylinders (100). The cover provides a protective layer between the mechanism and an occupant, hiding the mechanism and protecting it from dirt and other objects, and also provides a more aesthetically pleasing exterior design. In another embodiment of the exemplary seating surface (508), a friction reduction layer is installed over the gel cushion cylinders (100). A friction reduction layer made of a material with a low coefficient of friction such as parachute fabric or a silicone-coated fabric reduces the heat and sound generated by the gel cushion cylinders (100) as they ascend and descend within the exemplary seating surface (908).

In some embodiments, the worm gears (301) and worm screws (300) will be operable by a controller (not shown) such that an occupant can turn the system off or on and increase or decrease speed. This controller could have additional functions depending on a particular chair, such as activating heat elements or activating a chair lift. In some embodiments, the controller manages a motor (not shown) to vary the portion of the cycle of movement through which gel cushion cylinders (100) move each time, the speed with which they move, the amount of time between movements (or, substantially equivalently, the total cycle time), or some combination thereof. The exemplary seating surface (508) shown in FIG. 5 could in some embodiments be a modular seat cover rather than a permanently integrated seating surface. A modular seat cover could be easily removed for cleaning and maintenance, and it could also be installed atop a variety of seating surfaces.

In various embodiments, the groups of gel cushion cylinders (100) move in a cyclical pattern with a period (cycle time) of several minutes or more. In some such embodiments, while the cylinder movement is turned on, the cylinders rotate continuously, yielding a gradual change from one effective height pattern to another. In others, the cylinders move a portion of a cycle at regular (or irregular) intervals, then pause, yielding a more noticeable transition between height configurations. In some embodiments, the user can control the speed of the changes (or, equivalently, the cycle time), and in some embodiments the user can control the relative motions of different groups of cylinders.

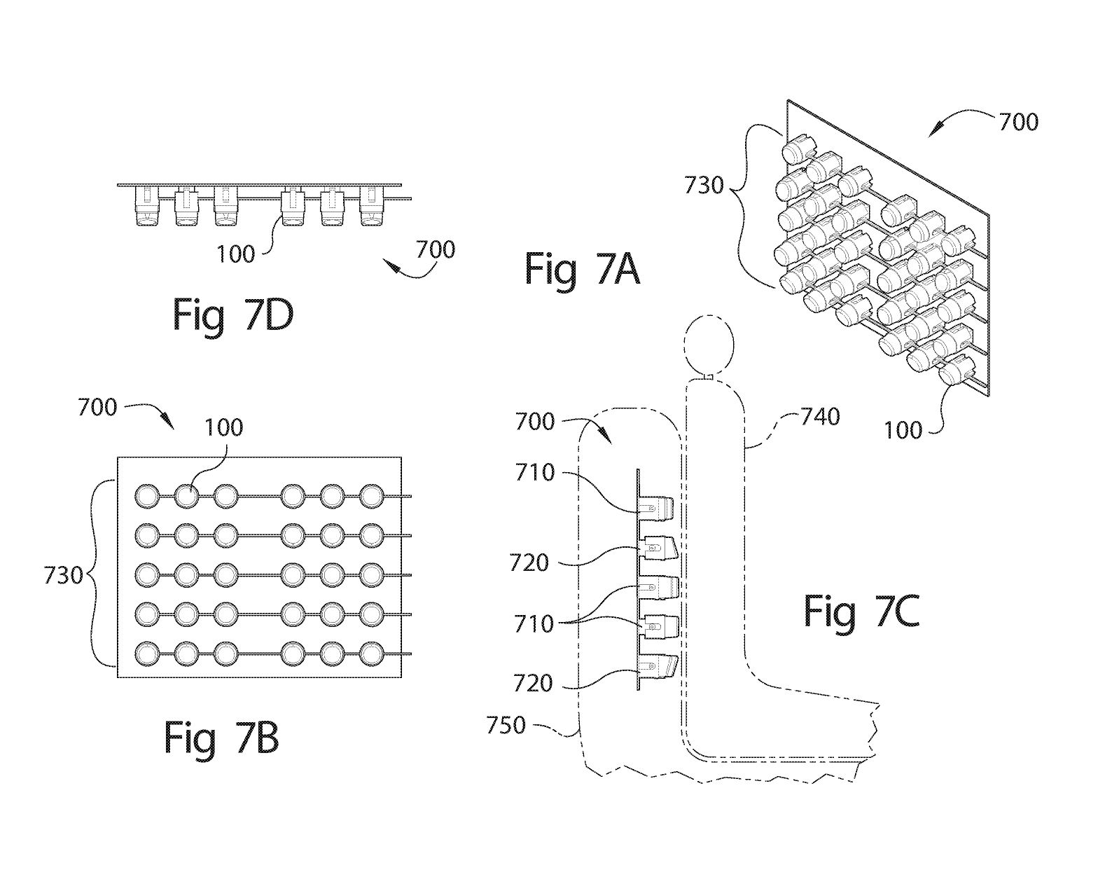

An alternative implementation of a gel cushion according to the present disclosure is illustrated in FIG. 7. In this implementation, cushion (700) includes groups of gel cushion cylinders (100) that contour to the lumbar and center back. Some of the gel cushion cylinders (100) have rounded tops (710), while others have angled tops (720). Gel cushion cylinders (100) are positioned in an array (730) that supports each side of the back of the user (740) as they sit in the chair (750). In similar embodiments, the array (730) alternatively or additionally supports the neck of user (740), and various combinations of (and placements of) rounded-top cylinders (710) and angled-top cylinders (720) are used.

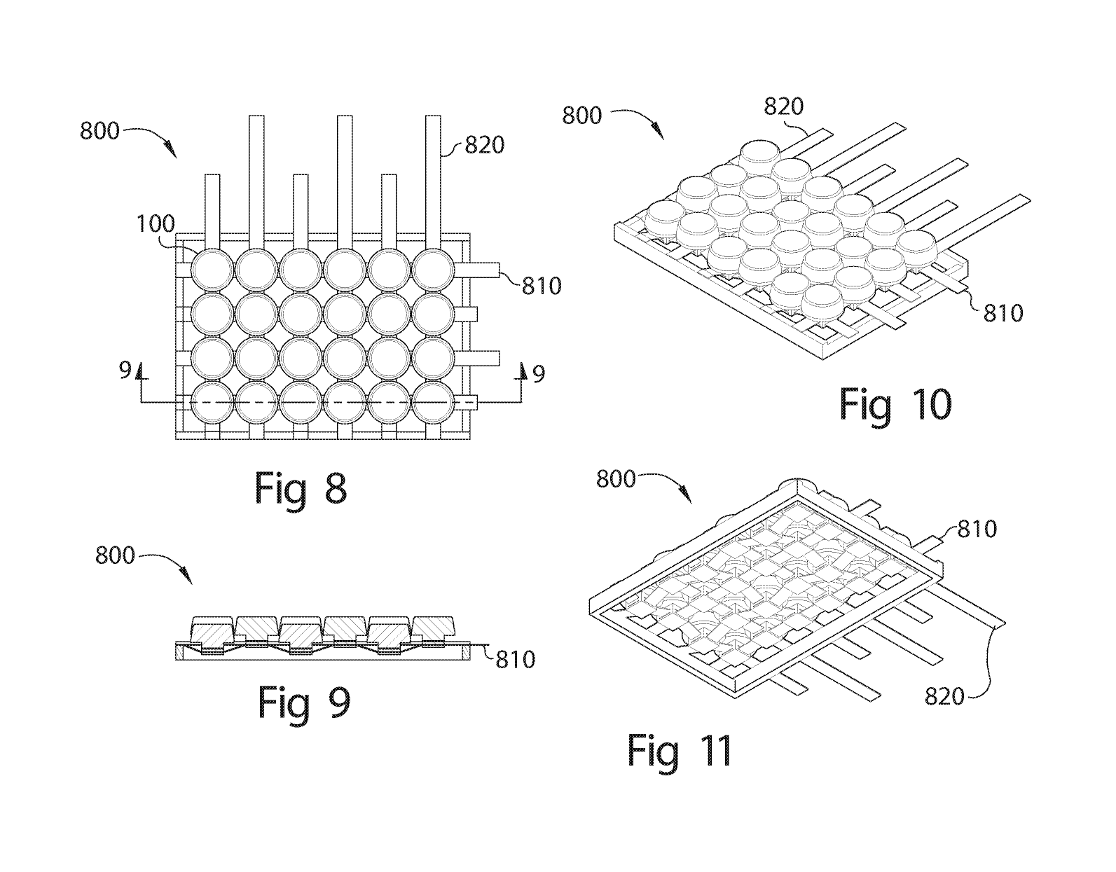

Other methods of causing the gel cushion cylinders (100) to ascend and descend are also possible. For example, another alternative implementation (800) is shown in FIGS. 8-11. Here, straps (810) and (820) pass under gel cushion cylinders (100) in perpendicular directions. These straps (810) and (820) are subjected to varying amounts of tension using any method that would occur to those skilled in the art, thereby subjecting each individual gel cushion cylinder (100) to a varying bias toward its fully raised position. In various implementations, straps (810) and (820) are made of nylon webbing, flexible plastic, other fabrics, or other materials as will occur to those skilled in the art.

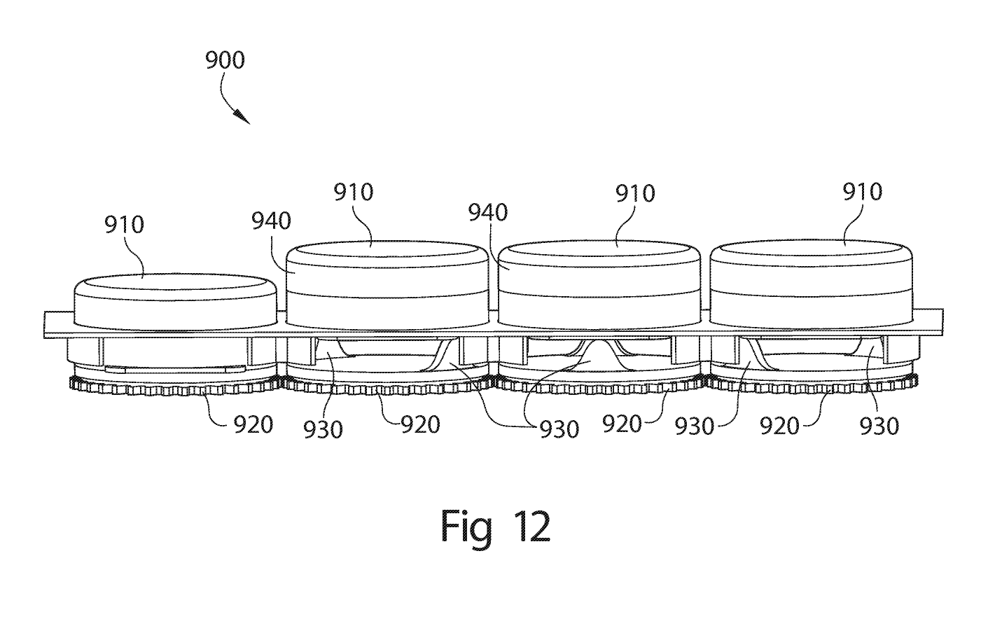

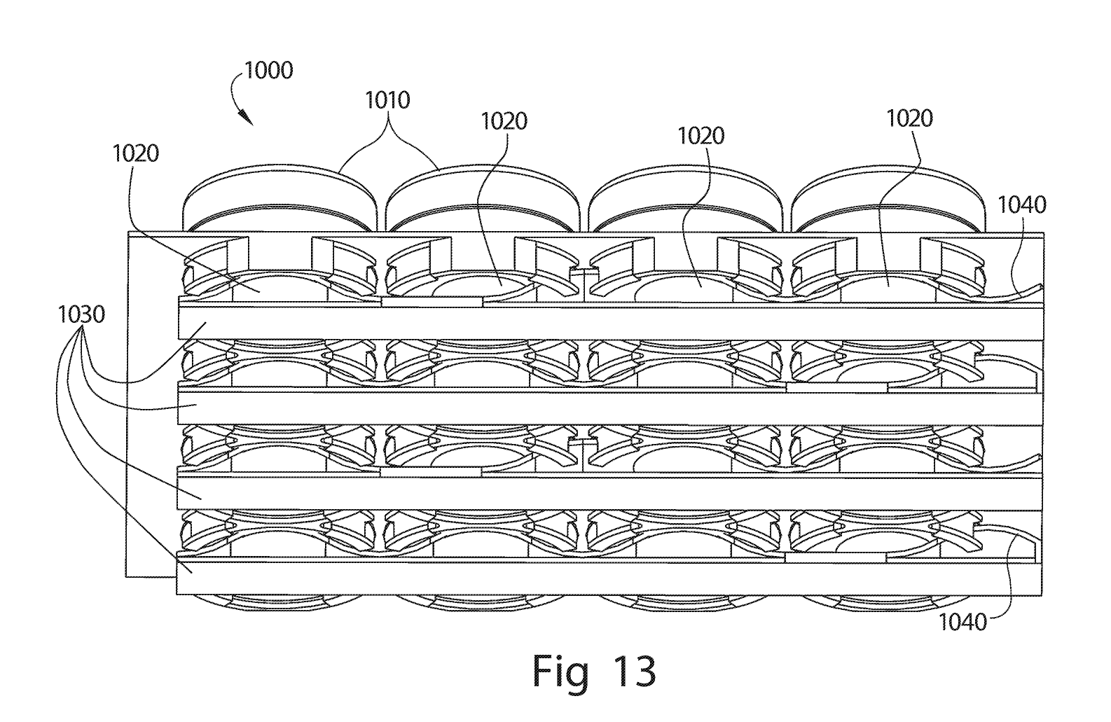

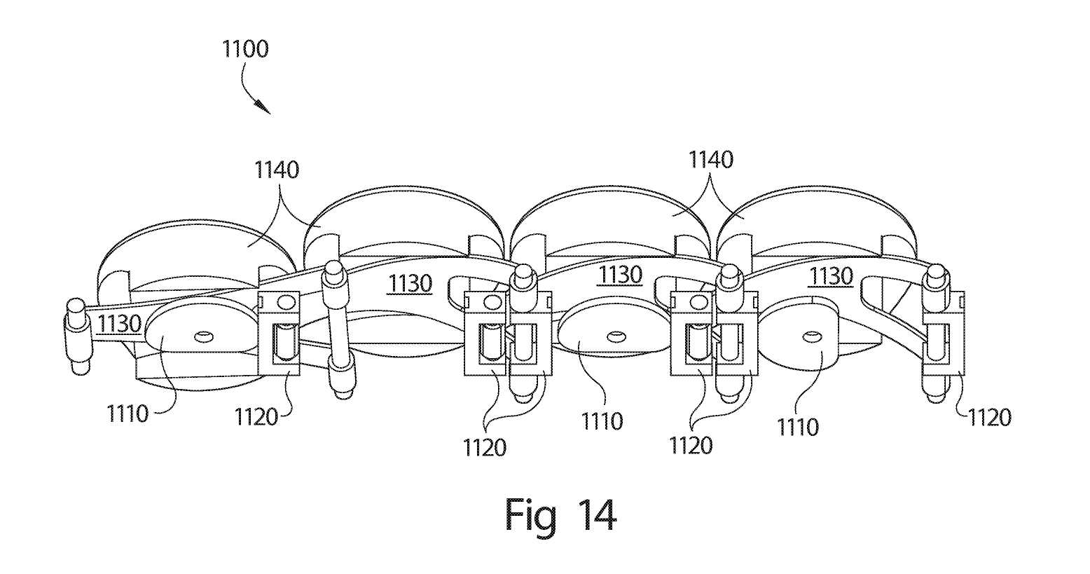

Yet another implementation (900) is shown in FIG. 12. Here, each gel cushion cylinder base (910) rests above a gear disc (920), and each gear disc (920) is in communication with its neighbor. Torque is transmitted directly or indirectly to the chain of gear discs (920), which each rotate about an axis substantially parallel to the centerline of the respective gel cushion cylinder base (910). On each gear disc (920) is a pair of protrusions (930) on opposite sides of the axis of rotation, and as each gear disc (920) rotates, the protrusions (930) travel along a circular path. When a pair of protrusions (930) aligns with spaces designed in an inner layer (not shown) of the support cylinder (940), the corresponding gel cushion cylinder base (910) is allowed to move to a lower position, as illustrated by the first gel cushion cylinder base (910) shown in FIG. 12. As the pair of protrusions (930) proceeds further along its circular path, the corresponding gel cushion cylinder base (910) is lifted back to its raised position, as illustrated by the other gel cushion cylinder bases (910) shown in FIG. 12.

In alternative forms of implementation (900), gear discs (920) do not have teeth, but transmit torque to each other by friction or other means as will occur to those skilled in the art. Thus, rotation of one gear disc (920) through a complete cycle corresponds to translation (in a direction perpendicular to the plane of rotation) of an adjacent gel cushion cylinder base (910) in a cyclical pattern. In various forms of implementation (900), the arrangement of protrusions (930) relative to each other and to the spaces designed in the inner layer (not shown) of the corresponding support cylinder (940) result in each of the set of gel cushion cylinder bases (910) being raised and lowered at different times.

Still another implementation (1000) has an array of gel cushion cylinders (represented by gel cushion cylinder bases (1010)) supported by support cylinders (1020). Below each row of support cylinders (1020) is a rectangular, substantially planar member (1030) and, attached to the substantially planar member (1030) at various points, and undulating member (1040). Thus, movement of the substantially planar member (1030) in the direction of its length results in different portions of the undulating member (1040) supporting each support cylinder (1020), and that changing contact moves each of the gel cushion cylinder bases (1010) through a cycle of positions in a direction perpendicular to the length of substantially planar member (1030).

In yet another implementation (1100), eccentrically shaped cam plates (1110) rotate in a common plane, thereby moving leaf brackets (1120) substantially along the line connecting their respective axes of rotation. Leaf springs (1130) are attached on each end to leaf brackets (1120), so when leaf brackets (1120) move, leaf springs (1130) raise and lower gel cushion cylinder bases (1140), each of which supports a gel cushion cylinder (not shown), through a cycle of motion.

In these various embodiments, the gel cushion cylinders (100) move in a cyclical pattern with a period (cycle time) of several minutes or more. In some such embodiments, while the cylinder movement is turned on, the cylinders move continuously, though slowly, yielding a gradual change from one effective height pattern to another. In others, the cylinders move a portion of a cycle at regular (or irregular) intervals, yielding a more noticeable transition between height configurations. In some embodiments, the user can control the speed of the changes (or, equivalently, the cycle time), and in some embodiments the user can (independently or collectively) control the relative motions of different groups of cylinders. In some embodiments, the user can control the height of the group of gel cushion cylinders at the lumbar location to support the lumbar while the cylinder positions are not cycling, while in others a user control, when triggered, causes all cells in a lumbar support to be extended for a period of time, then automatically retract, then return to a preset position.

Although the word “cylinders” has been used throughout to identify gel cushion cylinders (100), their actual structure in various embodiments takes a variety of forms. Some are, indeed, right circular cylinders, while others are substantially cubic, conical, hexagonal, frustoconical, pyramidal, or the like. The top portion of the “cylinders” closest to the person may be shaped to contour to the associated part of the body. or otherwise shaped as will occur to those skilled in the art in view of this disclosure.

Similarly, although the various embodiments described herein have been described in terms of a seat portion of furniture, “supportive furniture surface” should be interpreted in this description and the claims to include both permanent and removable cushion-like objects, whether for supporting the weight of a person while sitting or merely partially supporting a person's back or neck, and whether a separate component or integral part of a seat. These principles may be applied to reclining chairs, non-reclining chairs, office chairs, airplane seats (including pilot seats), over-the-road truck seats, automotive seats, healthcare seating (such as dialysis chairs), and the like, as will occur to those skilled in the art.

Likewise, the “array” or “grid” of cells in the various embodiments has been shown in square arrays or diagonal rows, but other regular and irregular layouts will occur to those skilled in the art in view of this disclosure, and those layouts can be used without straying from the invention.

Further variations on, features for, and applications of the inventors' technology will be immediately apparent to, and could be practiced without undue experimentation by, those of ordinary skill in the art in light of this disclosure.

What is claimed is:

1. A supportive furniture surface apparatus, comprising:
an array of support cells, each comprising a base that supports the volume of the formidably resilient material, and each aligned in substantially the same orientation;
a plurality of linkages, each operationally connected to a different plurality of support cells in the array; and
a motor operatively connected to the plurality of linkages to move each in a cyclical pattern.

2. The supportive furniture surface of claim 1, wherein the resilient, deformable material is directional variable foamed material.

3. The supportive furniture surface of claim 1,
further comprising a worm gear connecting the motor and the plurality of linkages; and
wherein torque from the motor is transmitted through the worm gear to the plurality of linkages, which each move their respective plurality of support cells through a cycle of motion.

4. The supportive furniture surface of claim 3, further comprising a controller that alternately
moves the worm gear through a portion of the cycle of motion, and
pauses for a period of time.

5. The supportive furniture surface of claim 4, wherein:
each portion of the cycle of motion is the same, and
each period of time is the same.

6. The supportive furniture surface of claim 4, wherein at least one of
the portion of the cycle of motion, and
the period of time
changes from time to time.

7. A supportive furniture surface, comprising:
a plurality of cells together forming at least a portion of a support surface, each cell comprising
a base;
a volume of resilient, deformable material supported by the base; and
a cam in operative communication with each of the plurality of cells such that,
by motion of the cam, the base of each cell moves through a cycle of positions, and
a first one and a second one of the plurality of cells are always at different points from each other in their respective cycles of positions.

8. The supportive furniture surface of claim 7, wherein the cam comprises one or more rods, each rod being:
attached to one or more of the plurality of cells operationally to move the base of each of the one or more cells through a range of positions when the rod is rotated; and
driven rotationally.

9. The supportive furniture surface of claim 7, wherein the cam comprises one or more discs, each disc:
being in operative communication with at least one other disc from the one or more discs; and
receiving torque from one or more drive sources selected from the drive class consisting of:
the at least one other disc, and
a motor;
wherein rotation of each of the one or more discs through a complete cycle translates an adjacent cell from the plurality of cells in a cyclical pattern.

10. The supportive furniture surface of claim 9, wherein the one or more discs directly communicate torque to each other.

11. The supportive furniture surface of claim 7, wherein the cam comprises:
a substantially planar member that passes beneath the plurality of cells substantially parallel to the support surface; and
an undulating member between the substantially planar member and the base of each of the plurality of cells, the undulating member being attached to the substantially planar member at a plurality of points;
wherein
the plurality of cells is arranged in a line in a first direction, and
movement of the substantially planar member in the first direction results in changing contact between the undulating member and the bases of the plurality of cells, and the changing contact moves each of the plurality of cells through a cycle of positions in a direction perpendicular to the first direction.

12. The supportive furniture surface of claim 7, wherein the cam comprises:
a plurality of eccentrically shaped cam plates in a common plane substantially parallel to the support surface;
a plurality of leaf brackets in the common plane; and
a plurality of leaf springs, each having a first and second attachment point, the first and second attachment points each being attached to a leaf bracket; and
a torque source that rotates each of the eccentrically shaped cam plates;
wherein the plurality of leaf springs together support the plurality of cells; and
rotation of the plurality of eccentrically shaped cam plates moves each of the plurality of support cells through a cycle of motion. But

[symbol]

13. The supportive furniture surface of claim 7, wherein the resilient, deformable material is directional variable foamed material.

14. The supportive furniture surface of claim 7, further comprising:
a worm gear; and
a drive motor that transmits torque thru the worm gear to the cam.

15. The supportive furniture surface of claim 14,
further comprising a controller operable to start and stop the drive motor, and
wherein the controller stops the drive motor at each of a plurality of positions in a cycle for a period of time, then moves to the next.

16. The supportive furniture surface of claim 15, wherein the period of time varies.

17. The supportive furniture surface of claim 15, wherein the period of time is substantially the same each time the controller stops the drive motor.

18. A method of supporting a person in a sitting or reclining position, comprising:
supporting the person with a plurality of resiliently deformable cells, each cell having a raised position and a lowered position, the plurality of cells being arranged in an array;
lowering a first portion of the plurality of cells, each from its raised position to its lowered position;
raising the first portion of the plurality of cells, each to its raised position; and
lowering a second portion of the plurality of cells, each from its raised position to its lowered position.

19. The method of supporting a person of claim 18, wherein raising the first portion of the plurality of cells and lowering the second portion of the plurality of cells occur, at least in part, simultaneously.

20. The method of supporting a person of claim 18, further comprising, after lowering the second portion of the plurality of cells:
raising the second portion of the plurality of cells, each to its raised position; and
lowering the first portion of the plurality of cells, each from its raised position to its lowered position.
